(19) United States
(12) Patent Application Publication
(10) Pub. No.: US 2026/0140850 A1
(43) Pub. Date: May 21, 2026

(54) SOFTWARE TESTING WITH FAILURE ACTION TEST CASE SELECTION

(71) Applicant: SAP SE, Walldorf (DE)

(72) Inventors: Nhat Hoa Tran, Ho Chi Minh City (VN); Chao Liu, Xi'an (CN); Yong Li, Xi'an (CN); Qiao-luan Xie, Xi'an (CN); Sascha Schwedes, Karlsruhe (DE); Thomas Bach, Rauenberg (DE)

(21) Appl. No.: 18/955,149

(22) Filed: Nov. 21, 2024

(51) Int. Cl. G06F 11/3668

(52) U.S. Cl. CPC G06F 11/368; G06F 11/3684

(57) ABSTRACT

Various examples are directed to systems and methods for testing software application. A testing system may access test case result data describing failed test cases executions of a plurality of test cases against the software application and, the test case result data describing a plurality of failed executions of the plurality of test cases. The testing system may determine a failure action metric describing a test case of the plurality of test cases and select a subset of the plurality of test cases based at least in part on the failure action metric. The testing system may execute the subset of test cases against the software application.

### BACKGROUND

Traditional modes of software development involve developing a software application and then performing error detection and debugging on the application before it is released to customers and/or other users. Error detection and debugging in this manner were time-consuming, largely manual activities.

### BRIEF DESCRIPTION OF DRAWINGS

The present disclosure is illustrated by way of example and not limitation in the following figures.

FIG. 1 is a diagram showing one example of an environment for software testing.

FIG. 2 is a diagram showing one example of a CI/CD pipeline incorporating various software testing described herein.

FIG. 3 is a flowchart showing one example of a process flow that may be executed in the environment of FIG. 1 to test a software application.

FIG. 4 is a diagram showing one example of a workflow that may be executed in the environment of FIG. 1 to determine a subset of test cases to be executed against a software application.

FIG. 5 is a block diagram showing one example of a software architecture for a computing device.

FIG. 6 is a block diagram of a machine in the example form of a computer system within which instructions may be executed to cause the machine to perform any one or more of the methodologies discussed herein.

### DETAILED DESCRIPTION

Various examples described herein are directed to software application testing and error detection with failure action test case selection.

In many software delivery environments, modifications to a software application are coded, tested, and sometimes released to users on a fast-paced timescale, sometimes quarterly, bi-weekly, or even daily. Also, large-scale software applications may be serviced by many software developers, with many developers and developer teams making modifications to the software application.

In some example arrangements, a continuous integration/continuous delivery (CI/CD) pipeline or similar arrangement is used to support a software application. According to a CI/CD pipeline, a developer entity maintains an integrated source of an application called a mainline or mainline build. The mainline build is the most recent build of the software application that has passed all testing. At release time, the mainline build is released to and may be installed at various production environments such as, for example, at public cloud environments, private cloud environments, and/or on-premise computing systems where users can access and utilize the software application.

Between releases, a development team or teams may work to update and maintain the software application. When it is desirable for a developer user to change the application, the developer user checks out a version of the mainline build from a code repository, such as a source code management (SCM) system. The mainline build is checked out into a local developer repository. The developer user builds modifications to the mainline. When the modifications are completed, the developer user initiates a commit operation. In the commit operation, the CI/CD pipeline executes a series of integration and acceptance tests to generate a new mainline build that includes the developer user's modifications. In some examples, the developer user may also initiate pre-submit testing. According to pre-submit testing, a commit operation and new build are generated and subjected to testing without the new build replacing all or part of the previous mainline build. Pre-submit testing may be used, for example, to allow developer users to test modifications to the software application between updates to the mainline build.

Applying the various integration and acceptance tests may comprise applying one or more test cases to a new build. A test case may comprise input data describing a set of input parameters provided to a build and result data describing how the build is expected to behave when provided with the set of input parameters. Executing a test case may comprise executing the software application (or a build thereof), providing the set of input parameters to the build, and observing how it responds. For example, a build may pass the test case if it generates an output that is equivalent to the result data. On the other hand, if the build crashes, generates incorrect output, or times out, this may be considered a failure of the test case.

When a new build suffers a failure of at least one test case, a failure action may be performed. The responsive action may include restoring a previous version of the build to prevent the potentially erroneous new build from reaching production. The responsive action may also include referring the new build to a developer user to identify and correct any errors in the build that may have caused the test case failure or failures. Sometimes, the developer user determines that the failed test case indicates a problem in the software application that can be addressed by changing the software application. In some examples, the developer user may change the software application by generating a new build that includes modifications to at least one file relative to a previous build. Also, in some examples, the developer user may change the software application by modifying the test case to change the way that the software application executes during the execution of the test case. For example, changes to the test case (e.g., different input data, instructions, and/or the like) may change the way a build of the software application executes.

In some examples, a test case may be flaky. A flaky test case is a test case that fails a build of the software application but does not indicate an error in the software application. For example, a flaky test case may fail a software application (e.g., a particular build thereof) on at least one execution of the test case and also pass the software application (e.g., the same build thereof) on at least one different execution of the test case.

A developer tasked with debugging or otherwise testing the software application may treat a test case failure differently if the failed test case is flaky. For example, when a software application (a build thereof) fails a test case that is not flaky, it may indicate that there is a bug or other error in the software application, and a modification may be made to the software application to fix the bug or other error. When a software application fails a flaky test case, however, the failure may not be indicative of any error or bug in the software application itself. The failure of a flaky test case, then, may indicate an error or bug in the software application, an error or bug in the testing system, or another issue. In some examples, developers may ignore failures of flaky test cases and/or may treat failures of flaky test cases differently than failures of non-flaky test cases. Accordingly, in some examples, it is desirable to identify flaky test cases.

In some examples, testing systems can be configured to detect flaky test cases. This may include rerunning failed test cases multiple times against the same build of the software application. In some examples, each failed test case is rerun three times, bringing the total number of executions for each failed test case to four. In other examples, failed test cases are rerun more or fewer than three times. After rerunning a test case, the testing system determines whether any of the rerun executions of the test case have passed the software application. If at least one of the rerun executions of the test case has passed the software application, then the testing system may determine that the test case is flaky. An indication that the test case is flaky may be provided to one or more developers, for example, along with the results of one or more other test case executions. The developer, in some examples, may ignore test case results from flaky test cases and/or may allocate resources away from flaky test cases and towards test case failures that are not flaky.

In some examples, the testing system may implement other algorithmic techniques for detecting flaky test cases based, for example, on timeout thresholds for the test cases and/or other properties or metrics describing the execution of failed test cases.

Test cases that are not identified as being flaky test cases are provided to developer users for further review and remediation, as described herein. In various examples, however, existing techniques for detecting flaky test cases generate significant false negatives. For example, many test case failures analyzed by developer users do not result in any modifications to the software application. This may be because a test case execution failed for reasons other than defects in the software application build. In some examples, this may be because a test case execution failed due to a minor or less important issue with the software application that does not need to be fixed immediately. For example, a minor fix that does not significantly impact the execution of the software application may be scheduled for fixing later.

Whatever their cause, flaky test cases can consume significant resources. For example, a flaky test case detection scheme that involves re-executing failed test cases multiple times can consume considerable time and computing resources. Flaky test case detection schemes that involve allowing developer users to determine the flakiness of a test case on a case-by-case basis can consume considerable developer user time and effort.

Various examples address these and other challenges by selecting test cases utilizing one or more failure action metrics and executing the selected test cases. Failure action metrics describing a test case may be based on whether previous failures of the test case resulted in modifications to the software application. In some examples, a failure action metric for a test case provides an indication of whether a future failure of the test case is likely to be a flaky failure (e.g., a failure that does not require additional action) or a failure that does result in a modification to the software application. A testing system may select a set of test cases for the execution of one or more failure action metrics. For example, the testing system may select test cases that are more likely to result in modifications to the software application upon failure.

This may reduce computing and other resources for addressing failed test case executions. For example, selecting and executing test cases that are less likely to be flaky may make it more likely that test case failures are less likely to be flaky. This may reduce the time and effort expended by testing systems and/or developer users addressing test case failures that are flaky and/or do not result in modifications to the software application.

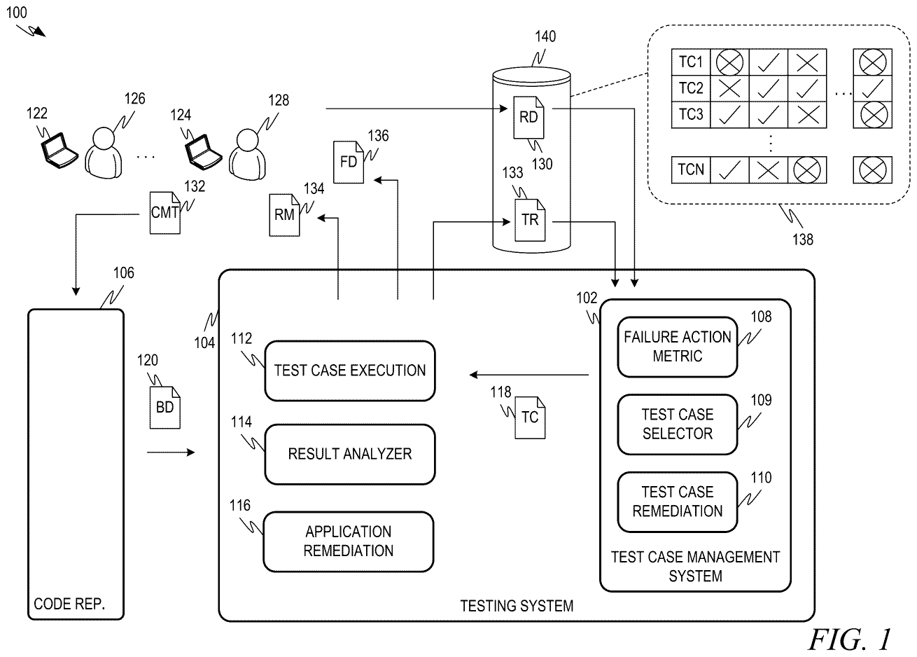

FIG. 1 is a diagram showing one example of an environment 100 for software testing. The environment 100 comprises a testing system 104, and a code repository 106, which may be all or part of an SCM system. In the example of FIG. 1, the test case management system 102 is a component of the testing system 104. It will be appreciated, however, that in some examples, the test case management system 102 may be distinct from the testing system 104.

The test case management system 102, testing system 104, and code repository 106 may include one or more computing devices that may be located at a single geographic location and/or distributed across different geographic locations. In some examples, the test case management system 102 and testing system 104 may be implemented at a common computing system, cloud installation, and/or the like.

One or more developer users 126, 128 may generate commit operations, such as commit operation 132. Developer users 126, 128 may utilize user computing devices 122, 124. User computing devices 122, 124 may be or include any suitable computing device such as, for example, desktop computers, laptop computers, tablet computers, mobile computing devices, and/or the like.

One or more of the developer users 126, 128 may check out a mainline of a software application from the code repository 106. The commit operation 132 may include changes to the previous mainline build. The commit operation 132 may result in a new build 120. In some examples, the new build 120 is subjected to pre-submit testing before it is submitted for incorporation into and/or replacement of the previous mainline. As described herein, this pre-submit testing can be initiated by the developer users 126, 128 as they develop the software application. In some examples, developer users 126, 128 will not submit a new build 120 for incorporation into and/or replacement of the previous mainline until it has passed pre-submit testing. Also, in some examples, submission of a new build 120 may happen periodically, such as for example, once a day, twice a day, every other day, and/or the like. New builds generated between periodic submissions may be subjected to pre-submit testing.

The testing system 104 may perform integration and acceptance tests on the changes implemented by the new build 120. The testing system 104 may comprise a test case execution system 112 for executing test cases, a result analyzer system 114 for analyzing results of test case executions, and an application remediation system 116 for mediating failed test case executions. The various systems 112, 114, 116 may be implemented using various hardware and/or software subcomponents of the testing system 104. In some examples, the systems 112, 114, 116 include an executable code or other software executed at a computing system or computing systems implementing the testing system 104. In some examples, one or more of the systems 112, 114, 116 are implemented on a discrete computing device or set of computing devices.

The testing system 104 is configured to test the new build 120 by executing one or more test cases. A test case may comprise input data describing a set of input parameters provided to a software application, such as the build 120, and result data describing how the software application is expected to behave when provided with the set of input parameters. The test case execution system 112 may execute a test case by executing the new build 120, applying the test parameters of the test case to the new build 120, and observing the response of the new build 120.

Consider an example in which the new build 120 is or includes a database management application. Test case data may comprise a set of one or more queries to be executed by the database management application and may result in data describing how the database management application should behave in response to the queries. The new build 120 may pass the test case if it generates the expected result data in response to the provided queries before the expiration of a timeout threshold. Conversely, the new build 120 may fail the test case if it fails to produce result data prior to the timeout threshold or generates result data that is different than the expected result data.

During pre-submit testing, results of the test cases may be provided to one or more of the developer users 126, 128. In this way, the developer users 126, 128 may make modifications to be incorporated into later builds. During submission testing, the results of the test cases may determine whether the new build 120 is deployed to supplement and/or replace the existing mainline build. For example, if the new build 120 passes all test cases, then it may be deployed as a new mainline build. If the new build 120 fails one or more test cases, it may not be deployed to supplement and/or replace the existing mainline build of the software application.

The result analyzer system 114 is configured to review the results of test case executions and determine whether the test case execution passed or failed the new build 120. The new build 120 may pass the test case if it responds to the input data in the way described by the result data. If a build fails to respond to the input data in the way described by the result data, the build may fail the test case. For example, if the new build 120 generates an output that is not consistent with the result data, the new build 120 may fail the test case execution. The new build 120 may also fail the test case execution, for example, if it fails to complete its execution prior to the timeout threshold for the test case execution. This may occur, for example, if the new build 120 has crashed or hung or, for example, if the new build 120 has not crashed but has, nonetheless, failed to complete its processing prior to the timeout threshold.

When the new build 120 fails one or more test cases, the result analyzer system 114 may generate data describing the failed test case. The data may include, for example, stack trace data and error message data. Stack trace data describes function calls made by the software application during the execution of a failed test case. For example, the stack trace data may include function names, line numbers, file names, source code lines, and or like data for each function called during the execution of the test case. Error message data includes error messages generated by the software application during the execution of the test case.

If the result analyzer system 114 determines that a test case execution has failed, the result analyzer system 114 may prompt the test case execution system 112 to re-execute the failed test case a number of times to determine whether the failed test case execution indicated a flaw in the new build 120 or a flaky test case. In some examples, there are three re-executions. If the software application fails all of the re-executions, then the result analyzer system 114 may prompt the application remediation system 116 to initiate a responsive action.

If the software application passes at least one of the additional executions, then the test case execution may be considered passed, and the test case may be considered flaky. In response, the result analyzer system 114 may provide a flaky test case message 136 to one or more developer users 126, 128. The flaky test case message 136 may include information about the flaky test case such as, for example, a pending stack trace data and/or error message data for the test case to the stack trace data and/or error message data for the known-flaky test cases described by the flaky test case data. In some examples, the flaky test message 136 is provided to the developer user 126, 128 who made the commit operation 132 to create the new build 120 and/or to a different developer user 126, 128. In some examples, a test case that is determined to be flaky may not be used for subsequent new builds, for example, until the flightiness of the test case has been addressed.

The application remediation system 116 and/or the test case execution system 112 may write test case result data 133 to a data store 140. The test case result data 133 may describe the result of test case executions. For example, the test case result data 133 may indicate whether the considered build has passed or failed each executed test case. The data store 140 may be associated with the testing system 104, the test case management system 102, and/or any other suitable computing system in communication with the testing system 104 and/or the test case management system 102.

The application remediation system 116 may execute one or more responsive actions when a new build 120 fails a test case execution and it is determined that the test case is not flaky, for example, if the new build 120 also fails all re-executions of the test case. In some examples, the application remediation system 116 sends a report message 134 to one or more developer users 126, 128. The report message 134 may comprise an indication of the commit operation 132 and/or the new build 120. In some examples, the report message 134 includes or describes the stack trace data of one or more crash failures of the new build 120 during the application of test cases. For example, report message 134 may provide an indication of a component or other portion of the software application that is associated with each function call in the stack trace data or stack trace data.

The report message 134 may also provide an indication of whether any crash failures of the new build 120 are duplicates of one another and/or duplicates of known errors in the software application. In some examples, the application remediation system 116 routes the report message 134 to the developer user 126, 128 that submitted the error-inducing commit operation or to a different developer user 126, 128.

Another example responsive action that may be taken by the application remediation system 116 includes reverting the software application to a good build. A good build may be a build that was generated by a commit operation prior to the commit operation 132. In some examples, the good build is the build generated by the commit operation immediately before the error-inducing commit operation 132. In some examples, the application remediation system 116 sends a report message 134 to a developer user 126, 128 and reverts the software application to the last good build, at least until the developer user 126, 128 has either modify the software application or determined that the failed test case does not require modification to the software application.

Upon receiving a report message 134, the developer user 126, 128 may analyze the failed test case execution or executions described by the report message 134 and determine a response. If the developer user 126, 128 determines that the failed test case execution calls for a modification to the software application, the developer user 126, 128 may make such a modification. This may include, for example, modifying one or more files of the software application. The developer user 126, 128 may modify one or more files of the software application, for example, by making a new commit operation leading to the creation of an additional new build. In some examples, the developer user 126, 128 may modify the software application by changing the failed test case in a manner that causes it to execute the software application in a different way. For example, the developer user 126, 128 may change prompts or other input data provided by the test case to the software application (e.g., a build thereof) during execution.

For some failed test cases, the developer user 126, 128 may examine the report message 134 (and/or other relevant data) and determine that no modification to the software application is called for. This may occur, for example, if the failed execution of the test case did not reveal a flaw in the software application (e.g., the considered build). This may also occur, for example, if the failed execution of the test case reveals a potential modification to the software application, but the potential modification is not a high priority.

The response of the developer user 126, 128 to a failed test case execution may be stored as response data 130 at the data store 140. FIG. 1 shows a table 138 that illustrates test case result data 133 and response data 130. In the example table 138, rows correspond to test cases TC1, TC2, TC3, TCN. Columns correspond to executions of the test case. Records including a checkmark indicate test case executions that passed the software application (e.g., build thereof). Records including an “X” indicate test case executions that failed the software application, but that did not result in modifications to the software application. Records including an “X” inside a circle indicate test case executions that failed the software applications and did result in modifications to the software application.

The test case management system 102 includes a failure action metric system 108, a test case selector 109, and a test case remediation system 110. The various systems 108, 109, 110 may be implemented using various hardware and/or software subcomponents of the test case management system 102 and/or the testing system 104. In some examples, the systems 108, 109, 110 include an executable code or other software executed at a computing system or computing systems implementing the test case management system 102 and/or the testing system 104. In some examples, one or more of the systems 108, 109, 110 are implemented on a discrete computing device or set of computing devices.

The failure action metric system 108 is configured to determine failure action metrics for executed test cases. Failure action metrics are metrics describing a portion of failed executions that result in one or more modifications to the software application. A response to a failed test case that results in one or more modifications to the software application is sometimes referred to herein as a failure action.

The failure action metric system 108 may be programmed to generate various failure action metrics describing executed test cases. In some examples, failure action metrics may be determined with respect to one or more time periods. Consider an example Equation [1] below:

$${FA}_{k} ( i ) = \{ {FA}_{k}^{i} , {FA}_{k}^{i - 1} , … {FA}_{k}^{i - T} \} \qquad [ 1 ]$$

Equation [1] shows a number of failure actions (e.g. test case failures resulting in one or more modifications to the software application) for a test case k occurring over a number of time periods. In Equation [1], k is an indicator of a particular test case. The number of failure actions for the test case is provided over a plurality of time periods, where the number of time periods in the plurality of time periods is given by T. The value i is a counting variable indicating a considered time period of the T time periods. Consider one example in which the plurality of time periods are weeks. In this example, each expression

$${FA}_{k}^{i}$$

indicates the number of failure actions for the test case in a given week i over T weeks. It will be appreciated that the time periods may have various different values. In some examples, the plurality of time periods may be days, hours, 12 hours, 24 hours, 48 hours, 72 hours, and/or the like. In some examples, the number T of the plurality of time periods may also vary. In some examples, the number T of the plurality of time periods may be based on the time covered by the test result data 133 and response data 130. In other examples, the number T of the plurality of time periods may be selected to cover a defined time such as, for example, the last month, the last six months, the last year, and the like.

One example failure action metric that may be determined for a test case is a failure action mean. A failure action mean describes a mean or average number of failure actions for a test case per time period over a plurality of the time periods. Referring to example Expression [1] above, a failure action mean per time period may be found by considering the number of failure actions for the test case across a plurality of time periods. Equation [2] shows one example way of determining a failure action mean for a test case k over a plurality of time periods i, where T is the number of time periods t in the plurality of time periods:

$${FA}_{k}^{mean} ( i ) = \frac{1}{T} \sum {FA}_{k} ( i ) = \frac{1}{T} {\sum }_{t = 0}^{T} {FA}_{k}^{i - t} \qquad [ 2 ]$$

Another example failure action metric that may be determined for a test case is a maximum number of failure actions for the test case in a time period. For example, a maximum failure action metric may indicate the number of failure actions for a test case in the time period having the highest number of failure actions for that test case. Equation [3] shows one example way of determining a maximum number of failure actions for a test case k in a time period over T time periods:

$${FA}_{k}^{max} ( i ) = max \{ {FA}_{k} ( i ) \} = max \{ {FA}_{k}^{i} , {FA}_{k}^{i - 1} , … {FA}_{k}^{i - T} \} \qquad [ 3 ]$$

Another example failure action metric that may be determined for a test case is a minimum number of failure actions for the test case in a time period. For example, a minimum failure action metric may indicate the number of failure actions for a test case in the time period having the lowest number of failure actions for that test case. Equation [4] shows one example way of determining a maximum number of failure actions for a test case k in a time period i over T time periods:

$${FA}_{k}^{min} ( i ) = min \{ {FA}_{k} ( i ) \} = min \{ {FA}_{k}^{i} , {FA}_{k}^{i - 1} , … {FA}_{k}^{i - T} \} \qquad [ 4 ]$$

In some examples, the failure action metric system 108 may generate mixed failure action metrics based on combinations of the mean, minimum, and/or maximum number of failure actions for a test case in a time period. Equation [5] below gives an example of a mixed failure action metric based on the mean, maximum, and minimum number of failure actions for a test case k in a time period over T time periods.

$${FA}_{k}^{mix} ( i ) = \frac{{FA}_{k}^{mean} ( i ) + {FA}_{k}^{max} ( i ) + {FA}_{k}^{min} ( i )}{3} \qquad [ 5 ]$$

It will be appreciated that some examples may include mixed failure action metrics based on combinations of two of the lien failure action metric, the maximum failure action metric, or the minimum failure action metric. It will also be appreciated that some examples may include mixed failure action metrics based on combinations of other failure action metrics.

In some examples, the failure action metric system 108 may weight failure actions. For example, failure actions for a test case occurring more recently may be weighted higher than failure actions for the test case that occurred further in the past. Equation [6] shows one example way of generating a weighted set of failure actions for a test case k over T time periods t:

$${FA}_{k}^{weighted} ( i ) = {\sum }_{t = 0}^{T} {β}^{t} \cdot {FA}_{k}^{i - t} \qquad [ 6 ]$$

In this example, β^{t} is a weighting factor that is different for each different time period t. In some examples, β^{t} has values between 0 and 1, with more recent time periods t corresponding to greater values of β^{t}. The failure action metric system 108 may utilize the weighted set of failure actions to generate weighted failure action metrics such as, a weighted mean failure action metric, a weighted maximum failure action metric, a weighted minimum failure action metric, one or more mixed weighted failure action metrics, and/or the like. For example, weighted failure action metrics may be determined by utilizing a weighted set of failure actions to generate one or more of the other failure action metrics described herein.

The test case selector 109 may utilize one or more failure action metrics values determined by the failure action metric system 108 to be executed against a build of the software application. The test case selector 109 may select test cases 118 having failure action metric values indicating that failures of the test case are more likely to result in modifications to the software application. For example, these test cases 118 may be more likely to provide useful information about the software application and less likely to utilize system and/or human resources analyzing test execution failures that will not result in modifications to the software application. The test cases 118 selected by the test case selector 109 may include less than all of the considered test cases described by the test result data 133 and/or the response data 130. For example, the test cases selected by the test case selector 109 may include some of the considered test cases and omit others.

The number of test cases in the subset may be determined in any suitable manner. In some examples, the type of testing to be performed and/or the available time for testing may be considered. For example, a testing situation with a limited amount of time may choose a smaller number of test cases having failure action metrics indicating the most failure actions.

The test case remediation system 110 may be programmed to refer test cases to a developer user 126, 128 based on failure action metrics calculated by the failure action metric system 108. For example, the test case remediation system 110 may compare one or more failure action metrics for a test case to a threshold condition. If the one or more failure action metrics for the considered test case condition meet the threshold condition, then the test case remediation system 110 may refer to the test case to a developer user 126, 128, who may analyze and make modifications to the test case. In some examples, the threshold condition may be indicative of a low number of test case failures resulting in changes to the software application. Such test cases may not provide high-quality testing of the software application.

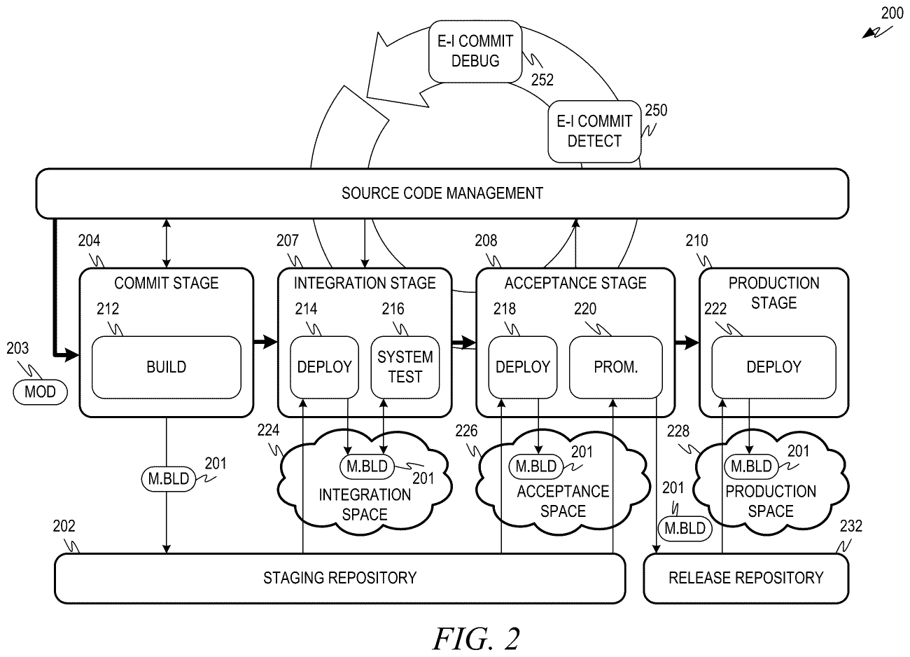

FIG. 2 is a diagram showing one example of a CI/CD pipeline 200 incorporating various software testing described herein. The CI/CD pipeline 200 is initiated when a developer user, such as one of developer users 126, 128, submits a build modification 203 to the commit stage 204, initiating a commit operation. The build modification 203 may include a modified version of the mainline build previously downloaded by the developer user 126, 128.

The commit stage 204 executes a commit operation 212 to create and/or refine the modified software application build 201. For example, the mainline may have changed since the time that the developer user 126, 128 downloaded the mainline version used to create the build modification 203. The modified software application build 201 generated by commit operation 212 includes the changes implemented by the modification 203 as well as any intervening changes to the mainline. The commit operation 212 and/or commit stage 204 stores the modified software application build 201 to a staging repository 202 where it can be accessed by various other stages of the CI/CD pipeline 200.

An integration stage 207 receives the modified software application build 201 for further testing. A deploy function 214 of the integration stage 207 deploys the modified software application build 201 to an integration space 224. The integration space 224 is a test environment to which the modified software application build 201 can be deployed for testing. While the modified software application build 201 is deployed at the integration space 224, a system test function 216 performs one or more integration tests on the modified software application build 201. In some examples, the testing system 104 of FIG. 1 may be utilized to perform all or part of the system test function 216, for example, using a subset of test cases selected by the test case selector 109. If the modified software application build 201 fails one or more of the test cases, it may be returned to the developer user 126, 128 for correction. If the modified software application build 201 passes testing, the integration stage 207 provides an indication indicating the passed testing to an acceptance stage 208.

The acceptance stage 208 uses a deploy function 218 to deploy the modified software application build 201 to an acceptance space 226. The acceptance space 226 is a test environment to which the modified software application build 201 can be deployed for testing. While the modified software application build 201 is deployed at the acceptance space 226, a promotion function 220 applies one or more promotion tests to determine whether the modified software application build 201 is suitable for deployment to a production environment. Example acceptance tests that may be applied by the promotion function 220 include Newman tests, UiVeri5 tests, Gauge BDD tests, various security tests, etc. If the modified software application build 201 fails the testing, it may be returned to the developer user 126, 128 for correction. If the modified software application build 201 passes the testing, the promotion function 220 may write the modified software application build 201 to a release repository 232, from which it may be deployed to production environments.

The example of FIG. 2 shows a single production stage 210. The production stage 210 includes a deploy function 222 that reads the modified software application build 201 from the release repository 232 and deploys the modified software application build 201 to a production space 228. The production space 228 may be any suitable production space or environment as described herein.

The various examples for software testing described herein may be implemented during the acceptance stage 208 and/or the integration stage 207. An error-inducing detection operation 250 may be executed by the testing system 104 utilizing fault localization, for example. An error-inducing commit debug or correction operation 252 may be executed by the testing system 104 (e.g., the application remediation system 116) as described herein.

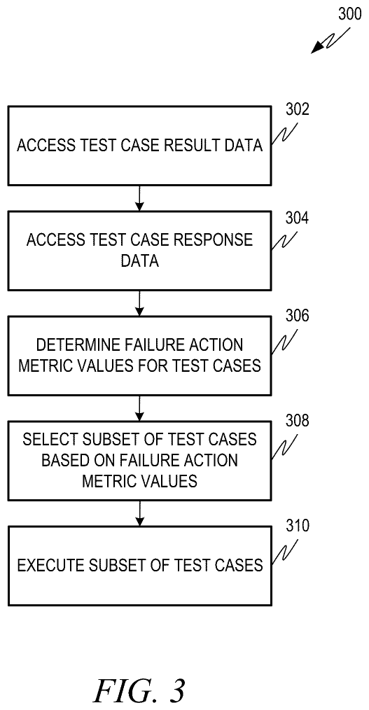

FIG. 3 is a flowchart showing one example of a process flow 300 that may be executed in the environment 100 of FIG. 1 to test a software application. At operation 302, the test case management system 102 may access test case execution data 133. The test case result data may describe the results of executing a plurality of test cases against a software application and/or one or more build thereof. At least some of the test case executions described by the test case result data may be failed test case executions.

At operation 304, the test case management system 102 may access test case response data 130. The test case response data 130 may describe responses to failed test case executions including, for example, whether failed test case executions resulted in one or more modifications to the software application.

At operation 306, the test case management system 102 may determine one or more failure metric values for one or more of the test cases described by the test case execution data 133 and test case response data 130. Any suitable failure action metric or metrics may be calculated for the test cases including, for example, the failure action metrics described herein.

At operation 308, the test case management system 102 may select a subset of the test cases based on the failure action metric values determined at operation 306. As described herein, the subset of the test cases may also be selected based on other data such as, for example, an indication of testing time available, a stage of testing, and/or the like. The subset of test cases may be selected to include test cases having failure action metrics indicating greater numbers of failure actions (e.g., greater numbers of failed executions resulting in modifications to the software application). For example, the subset of test cases may comprise test cases having higher mean failure action metrics, higher maximum failure action metrics, lower minimum failure action metrics, higher weighted failure action metrics, and/or the like. At operation 310, the testing system 104 may execute the subset of test cases against a build of the software application.

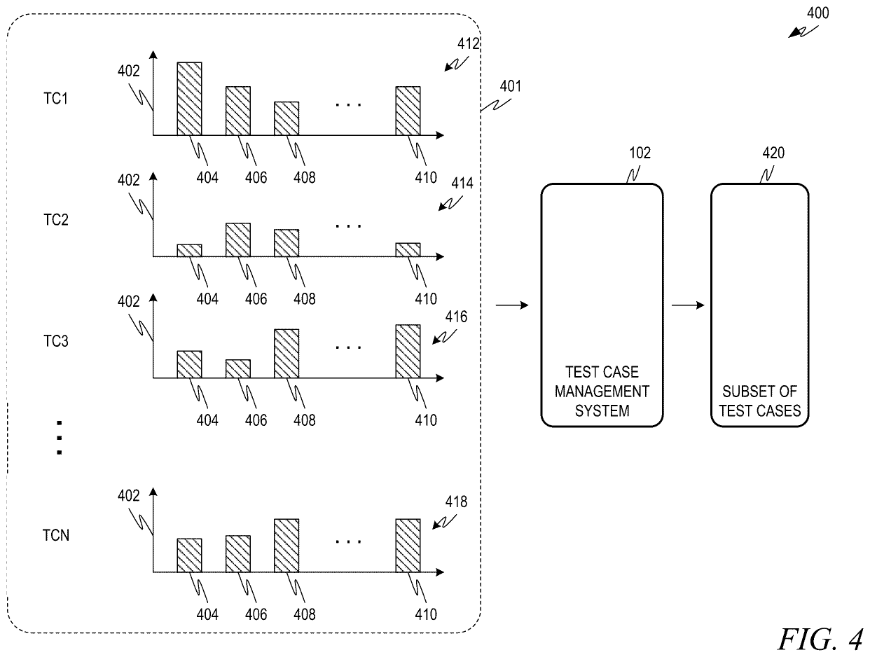

FIG. 4 is a diagram showing one example of a workflow 400 that may be executed in the environment 100 of FIG. 1 to determine a subset 420 of test cases to be executed against a software application. FIG. 4 includes graphical representations 412, 414, 416, 418 of test case data 401 describing example test cases labeled TC1, TC2, TC3 . . . . TCN. Each of the graphical representations 412, 414, 416, 418 is displayed on a horizontal axis indicating time periods 404, 406, 408, 410 and a vertical axis 402 indicating a number of failure actions. The bars at the respective graphical representations 412, 414, 416, 418 represent the number of failure actions for the respective test cases in each of the time periods 404, 406, 408, 410.

The test case data 401 may be provided to the test case management system 102. The test case management system 102 may determine one or more failure action metric values based on the test case data 401 and may select a subset 420 of test cases for execution based on the failure action metric values.

In view of the disclosure above, various examples are set forth below. It should be noted that one or more features of an example, taken in isolation or combination, should be considered within the disclosure of this application.

### EXAMPLES

Example 1 is a system for testing a software application, the system comprising: at least one processor programmed to perform operations comprising: accessing test case result data describing failed test cases executions of a plurality of test cases against the software application, the test case result data describing a plurality of failed executions of a first test case of the plurality of test cases and a second plurality of failed executions of a second test case of the plurality of test cases; accessing failed test case response data describing actions performed in response to at least a portion of the failed test case executions, the failed test case response data describing respective responses to the plurality of failed executions of the first test case and respective responses to the second plurality of failed executions of the second test case; determining a first failure action metric value for the first test case based at least in part on a number of the respective responses to the plurality of failed executions of the first test case that included modifying the software application; determining a second failure action metric value for the second test case based at least in part on a number of the respective responses to the second plurality of failed executions of the second test case that included modifying the software application; selecting a subset of the plurality of test cases based at least in part on the first failure action metric value and the second failure action metric value, the subset of the plurality of test cases comprising the first test case and omitting the second test case; and executing the subset of the plurality of test cases against the software application.

In Example 2, the subject matter of Example 1 optionally includes the number of the respective responses of the plurality of failed executions of the first test case that included modifying the software application being greater than the number of the respective responses to the second plurality of failed executions of the second test case that included modifying the software application.

In Example 3, the subject matter of any one or more of Examples 1-2 optionally includes the determining of the first failure action metric value comprising determining a mean number of the respective responses to the plurality of failed executions of the first test case that included modifying the software application per time period over a plurality of time periods.

In Example 4, the subject matter of any one or more of Examples 1-3 optionally includes the determining of the first failure action metric value comprising determining a first time period of a plurality of time periods during which a highest number of the respective responses to the plurality of failed executions of the first test case included modifying the software application.

In Example 5, the subject matter of any one or more of Examples 1-4 optionally includes the determining of the first failure action metric value comprising determining a first time period of a plurality of time periods during which a lowest number of the respective responses to the plurality of failed executions of the first test case included modifying the software application.

In Example 6, the subject matter of any one or more of Examples 1-5 optionally includes the determining of the first failure action metric value comprising: determining a mean number of the respective responses to the plurality of failed executions of the first test case during a plurality of time periods that included modifying the software application; determining a second time period of the plurality of time periods during which a highest number of the respective responses to the plurality of failed executions of the first test case included modifying the software application; and determining a third time period of the plurality of time periods during which a lowest number of the respective responses to the plurality of failed executions of the first test case included modifying the software application.

In Example 7, the subject matter of any one or more of Examples 1-6 optionally includes the determining of the first failure action metric value comprising: applying a first weight to a number of the respective responses to the plurality of failed executions of the first test case during a first time period that included modifying the software application to generate a first weighted number; and applying a second weight to a number of the respective responses to the plurality of failed executions of the first test case during a second time period that included modifying the software application to generate a second weighted number, the first failure action metric value being based at least in part on the first weighted number and the second weighted number.

In Example 8, the subject matter of Example 7 optionally includes the first time period being more recent than the second time period, and the first weight being greater than the second weight.

In Example 9, the subject matter of any one or more of Examples 1-8 optionally includes the operations further comprising: determining that the second failure action metric value for the second test case meets a threshold condition; and responsive to determining that the second failure action metric value for the second test case meets the threshold condition, prompting a modification to the second test case.

In Example 10, the subject matter of any one or more of Examples 1-9 optionally includes the respective responses to the plurality of failed executions of the first test case that included modifying the software application comprising: a first response to a first failed execution of the plurality of failed executions of first test case that included modifying at least one file associated with the software application; and a second response to a second failed execution of the plurality of failed executions of first test case that included modifying the first test case to change how the first test case executes the software application.

Example 11 is a method of testing a software application, comprising: accessing test case result data describing failed test cases executions of a plurality of test cases against the software application, the test case result data describing a plurality of failed executions of a first test case of the plurality of test cases and a second plurality of failed executions of a second test case of the plurality of test cases; accessing failed test case response data describing actions performed in response to at least a portion of the failed test case executions, the failed test case response data describing respective responses to the plurality of failed executions of the first test case and respective responses to the second plurality of failed executions of the second test case; determining a first failure action metric value for the first test case based at least in part on a number of the respective responses to the plurality of failed executions of the first test case that included modifying the software application; determining a second failure action metric value for the second test case based at least in part on a number of the respective responses to the second plurality of failed executions of the second test case that included modifying the software application; selecting a subset of the plurality of test cases based at least in part on the first failure action metric value and the second failure action metric value, the subset of the plurality of test cases comprising the first test case and omitting the second test case; and executing the subset of the plurality of test cases against the software application.

In Example 12, the subject matter of Example 11 optionally includes the number of the respective responses of the plurality of failed executions of the first test case that included modifying the software application being greater than the number of the respective responses to the second plurality of failed executions of the second test case that included modifying the software application.

In Example 13, the subject matter of any one or more of Examples 11-12 optionally includes the determining of the first failure action metric value comprising determining a mean number of the respective responses to the plurality of failed executions of the first test case that included modifying the software application per time period over a plurality of time periods.

In Example 14, the subject matter of any one or more of Examples 11-13 optionally includes the determining of the first failure action metric value comprising determining a first time period of a plurality of time periods during which a highest number of the respective responses to the plurality of failed executions of the first test case included modifying the software application.

In Example 15, the subject matter of any one or more of Examples 11-14 optionally includes the determining of the first failure action metric value comprising determining a first time period of a plurality of time periods during which a lowest number of the respective responses to the plurality of failed executions of the first test case included modifying the software application.

In Example 16, the subject matter of any one or more of Examples 11-15 optionally includes the determining of the first failure action metric value comprising: determining a mean number of the respective responses to the plurality of failed executions of the first test case during a plurality of time periods that included modifying the software application; determining a second time period of the plurality of time periods during which a highest number of the respective responses to the plurality of failed executions of the first test case included modifying the software application; and determining a third time period of the plurality of time periods during which a lowest number of the respective responses to the plurality of failed executions of the first test case included modifying the software application.

In Example 17, the subject matter of any one or more of Examples 11-16 optionally includes the determining of the first failure action metric value comprising: applying a first weight to a number of the respective responses to the plurality of failed executions of the first test case during a first time period that included modifying the software application to generate a first weighted number; and applying a second weight to a number of the respective responses to the plurality of failed executions of the first test case during a second time period that included modifying the software application to generate a second weighted number, the first failure action metric value being based at least in part on the first weighted number and the second weighted number.

In Example 18, the subject matter of Example 17 optionally includes the first time period being more recent than the second time period, and the first weight being greater than the second weight.

In Example 19, the subject matter of any one or more of Examples 11-18 optionally includes determining that the second failure action metric value for the second test case meets a threshold condition; and responsive to determining that the second failure action metric value for the second test case meets the threshold condition, prompting a modification to the second test case.

Example 20 is a non-transitory machine-readable medium comprising instructions thereon that, when executed by at least one processor, cause the at least one processor to perform operations comprising: accessing test case result data describing failed test cases executions of a plurality of test cases against a software application, the test case result data describing a plurality of failed executions of a first test case of the plurality of test cases and a second plurality of failed executions of a second test case of the plurality of test cases; accessing failed test case response data describing actions performed in response to at least a portion of the failed test case executions, the failed test case response data describing respective responses to the plurality of failed executions of the first test case and respective responses to the second plurality of failed executions of the second test case; determining a first failure action metric value for the first test case based at least in part on a number of the respective responses to the plurality of failed executions of the first test case that included modifying the software application; determining a second failure action metric value for the second test case based at least in part on a number of the respective responses to the second plurality of failed executions of the second test case that included modifying the software application; selecting a subset of the plurality of test cases based at least in part on the first failure action metric value and the second failure action metric value, the subset of the plurality of test cases comprising the first test case and omitting the second test case; and executing the subset of the plurality of test cases against the software application.

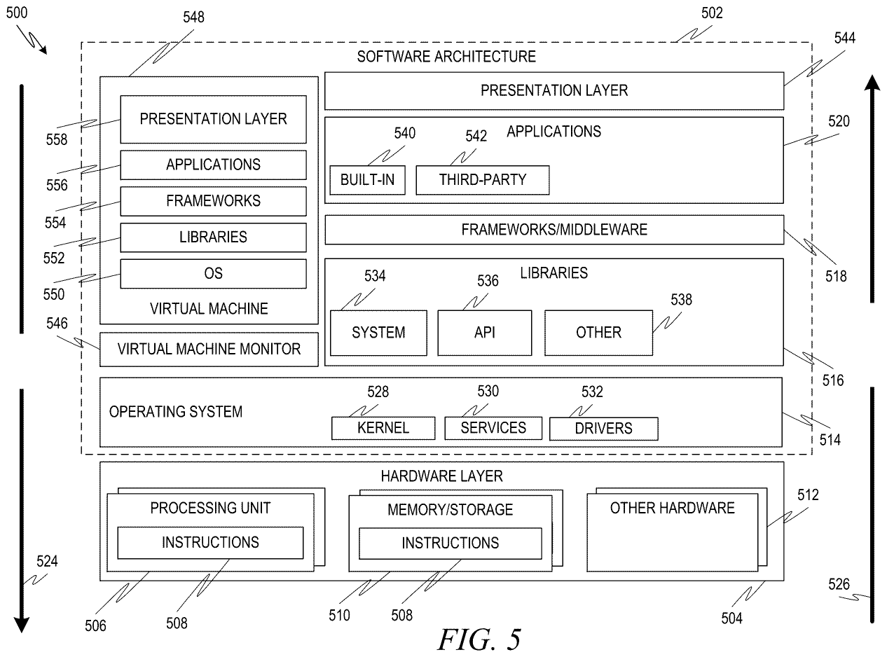

FIG. 5 is a block diagram 500 showing one example of a software architecture 502 for a computing device. The software architecture 502 may be used in conjunction with various hardware architectures, for example, as described herein. FIG. 5 is merely a non-limiting example of a software architecture and many other architectures may be implemented to facilitate the functionality described herein. The software architecture 502 and various other components described in FIG. 5 may be used to implement various other systems described herein. For example, the software architecture 502 shows one example way for implementing a testing system 104 or other computing devices described herein.

In FIG. 5, a representative hardware layer 504 is illustrated and can represent, for example, any of the above referenced computing devices. In some examples, the hardware layer 504 may be implemented according to the architecture of the computer system of FIG. 5.

The representative hardware layer 504 comprises one or more processing units 506 having associated executable instructions 508. Executable instructions 508 represent the executable instructions of the software architecture 502, including implementation of the methods, modules, systems, and components, and so forth described herein and may also include memory and/or storage modules 510, which also have executable instructions 508. Hardware layer 504 may also comprise other hardware as indicated by other hardware 512 which represents any other hardware of the hardware layer 504, such as the other hardware illustrated as part of the software architecture 502.

In the example architecture of FIG. 5, the software architecture 502 may be conceptualized as a stack of layers where each layer provides particular functionality. For example, the software architecture 502 may include layers such as an operating system 514, libraries 516, middleware layer 518 (sometimes referred to as frameworks), applications 520, and presentation layer 544. Operationally, the applications 520 and/or other components within the layers may invoke API calls 524 through the software stack and access a response, returned values, and so forth illustrated as messages 526 in response to the API calls 524. The layers illustrated are representative in nature and not all software architectures have all layers. For example, some mobile or special purpose operating systems may not provide the middleware layer 518, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. In some examples, the services 530 include an interrupt service. The interrupt service may detect the receipt of an interrupt and, in response, cause the software architecture 502 to pause its current processing and execute an interrupt service routine (ISR) when an interrupt is accessed.

The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 516 may include system 534 libraries (e.g., C standard library) that may provide functions such as memory allocation functions, string manipulation functions, mathematic functions, and/or the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 516 may also include a wide variety of other libraries 538 to provide many other APIs to the applications 520 and other software components/modules.

The middleware layer 518 (also sometimes referred to as frameworks) may provide a higher-level common infrastructure that may be utilized by the applications 520 and/or other software components/modules. For example, the middleware layer 518 may provide various graphic user interface (GUI) functions, high-level resource management, high-level location services, and so forth. The middleware layer 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any of the built-in applications 540 as well as a broad assortment of other applications. In a specific example, the third-party application 542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 542 may invoke the API calls 524 provided by the mobile operating system, such as operating system 514, to facilitate functionality described herein.

The applications 520 may utilize built-in operating system functions (e.g., kernel 528, services 530 and/or drivers 532), libraries (e.g., system 534, API libraries 536, and other libraries 538), and middleware layer 518 to create user interfaces to interact with users of the system. Alternatively, or additionally, in some systems interactions with a user may occur through a presentation layer, such as presentation layer 544. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 5 illustrates by virtual machine 548. A virtual machine creates a software environment where applications/modules can execute as if they were executing on a hardware computing device. A virtual machine 548 is hosted by a host operating system (operating system 514) and typically, although not always, has a virtual machine monitor 546, which manages the operation of the virtual machine 548 as well as the interface with the host operating system (i.e., operating system 514). A software archite 110

cture executes within the virtual machine 548. The software architecture may be or include, for example, an operating system 550, libraries 552, frameworks/middleware 554, applications 556 and/or presentation layer 558. These layers of software architecture executing within the virtual machine 548 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

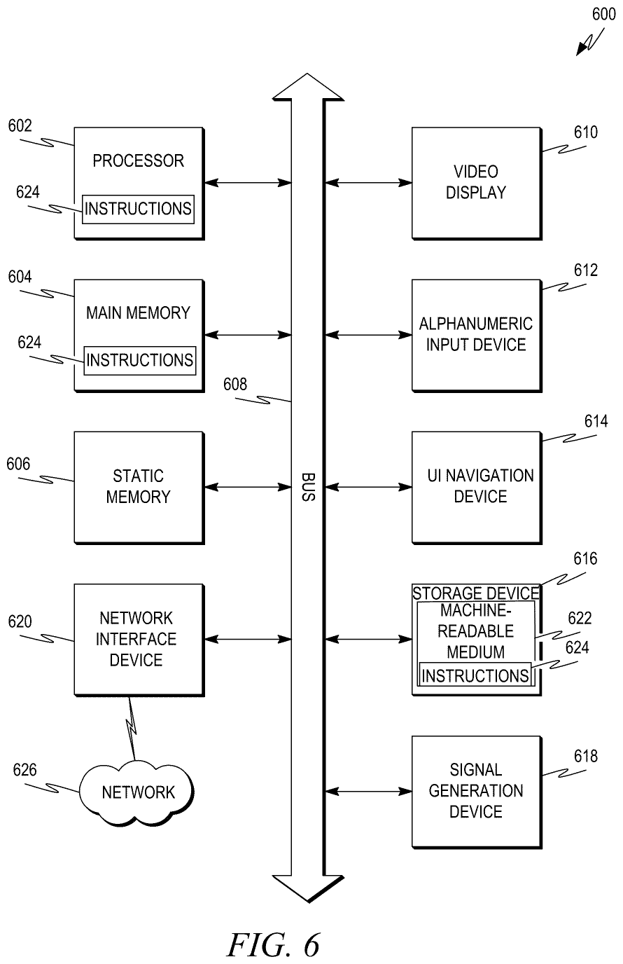

FIG. 6 is a block diagram of a machine in the example form of a computer system 600 within which instructions 624 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch-sensitive display screen), a user interface (UI) navigation (or cursor control) device 614 (e.g., a mouse), a storage device 616, such as a disk drive unit, a signal generation device 618 (e.g., a speaker), and a network interface device 620.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media 622.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for testing a software application, the system comprising:
at least one processor programmed to perform operations comprising:
accessing test case result data describing failed test cases executions of a plurality of test cases against the software application, the test case result data describing a plurality of failed executions of a first test case of the plurality of test cases and a second plurality of failed executions of a second test case of the plurality of test cases;
accessing failed test case response data describing actions performed in response to at least a portion of the failed test case executions, the failed test case response data describing respective responses to the plurality of failed executions of the first test case and respective responses to the second plurality of failed executions of the second test case;
determining a first failure action metric value for the first test case based at least in part on a number of the respective responses to the plurality of failed executions of the first test case that included modifying the software application;
determining a second failure action metric value for the second test case based at least in part on a number of the respective responses to the second plurality of failed executions of the second test case that included modifying the software application;
selecting a subset of the plurality of test cases based at least in part on the first failure action metric value and the second failure action metric value, the subset of the plurality of test cases comprising the first test case and omitting the second test case; and
executing the subset of the plurality of test cases against the software application.

2. The system of claim 1, the number of the respective responses of the plurality of failed executions of the first test case that included modifying the software application being greater than the number of the respective responses to the second plurality of failed executions of the second test case that included modifying the software application.

3. The system of claim 1, the determining of the first failure action metric value comprising determining a mean number of the respective responses to the plurality of failed executions of the first test case that included modifying the software application per time period over a plurality of time periods.

4. The system of claim 1, the determining of the first failure action metric value comprising determining a first time period of a plurality of time periods during which a highest number of the respective responses to the plurality of failed executions of the first test case included modifying the software application.

5. The system of claim 1, the determining of the first failure action metric value comprising determining a first time period of a plurality of time periods during which a lowest number of the respective responses to the plurality of failed executions of the first test case included modifying the software application.

6. The system of claim 1, the determining of the first failure action metric value comprising:
determining a mean number of the respective responses to the plurality of failed executions of the first test case during a plurality of time periods that included modifying the software application;
determining a second time period of the plurality of time periods during which a highest number of the respective responses to the plurality of failed executions of the first test case included modifying the software application; and
determining a third time period of the plurality of time periods during which a lowest number of the respective responses to the plurality of failed executions of the first test case included modifying the software application.

7. The system of claim 1, the determining of the first failure action metric value comprising:
applying a first weight to a number of the respective responses to the plurality of failed executions of the first test case during a first time period that included modifying the software application to generate a first weighted number; and
applying a second weight to a number of the respective responses to the plurality of failed executions of the first test case during a second time period that included modifying the software application to generate a second weighted number, the first failure action metric value being based at least in part on the first weighted number and the second weighted number.

8. The system of claim 7, the first time period being more recent than the second time period, and the first weight being greater than the second weight.

9. The system of claim 1, the operations further comprising:
determining that the second failure action metric value for the second test case meets a threshold condition; and
responsive to determining that the second failure action metric value for the second test case meets the threshold condition, prompting a modification to the second test case.

10. The system of claim 1, the respective responses to the plurality of failed executions of the first test case that included modifying the software application comprising:
a first response to a first failed execution of the plurality of failed executions of first test case that included modifying at least one file associated with the software application; and
a second response to a second failed execution of the plurality of failed executions of first test case that included modifying the first test case to change how the first test case executes the software application.

11. A method of testing a software application, comprising:
accessing test case result data describing failed test cases executions of a plurality of test cases against the software application, the test case result data describing a plurality of failed executions of a first test case of the plurality of test cases and a second plurality of failed executions of a second test case of the plurality of test cases;
accessing failed test case response data describing actions performed in response to at least a portion of the failed test case executions, the failed test case response data describing respective responses to the plurality of failed executions of the first test case and respective responses to the second plurality of failed executions of the second test case;
determining a first failure action metric value for the first test case based at least in part on a number of the respective responses to the plurality of failed executions of the first test case that included modifying the software application;
determining a second failure action metric value for the second test case based at least in part on a number of the respective responses to the second plurality of failed executions of the second test case that included modifying the software application;
selecting a subset of the plurality of test cases based at least in part on the first failure action metric value and the second failure action metric value, the subset of the plurality of test cases comprising the first test case and omitting the second test case; and
executing the subset of the plurality of test cases against the software application.

12. The method of claim 11, the number of the respective responses of the plurality of failed executions of the first test case that included modifying the software application being greater than the number of the respective responses to the second plurality of failed executions of the second test case that included modifying the software application.

13. The method of claim 11, the determining of the first failure action metric value comprising determining a mean number of the respective responses to the plurality of failed executions of the first test case that included modifying the software application per time period over a plurality of time periods.

14. The method of claim 11, the determining of the first failure action metric value comprising determining a first time period of a plurality of time periods during which a highest number of the respective responses to the plurality of failed executions of the first test case included modifying the software application.

15. The method of claim 11, the determining of the first failure action metric value comprising determining a first time period of a plurality of time periods during which a lowest number of the respective responses to the plurality of failed executions of the first test case included modifying the software application.

16. The method of claim 11, the determining of the first failure action metric value comprising:
determining a mean number of the respective responses to the plurality of failed executions of the first test case during a plurality of time periods that included modifying the software application;
determining a second time period of the plurality of time periods during which a highest number of the respective responses to the plurality of failed executions of the first test case included modifying the software application; and
determining a third time period of the plurality of time periods during which a lowest number of the respective responses to the plurality of failed executions of the first test case included modifying the software application.

17. The method of claim 11, the determining of the first failure action metric value comprising:
applying a first weight to a number of the respective responses to the plurality of failed executions of the first test case during a first time period that included modifying the software application to generate a first weighted number; and
applying a second weight to a number of the respective responses to the plurality of failed executions of the first test case during a second time period that included modifying the software application to generate a second weighted number, the first failure action metric value being based at least in part on the first weighted number and the second weighted number.

18. The method of claim 17, the first time period being more recent than the second time period, and the first weight being greater than the second weight.

19. The method of claim 11, further comprising:
determining that the second failure action metric value for the second test case meets a threshold condition; and
responsive to determining that the second failure action metric value for the second test case meets the threshold condition, prompting a modification to the second test case.

20. A non-transitory machine-readable medium comprising instructions thereon that, when executed by at least one processor, cause the at least one processor to perform operations comprising:
accessing test case result data describing failed test cases executions of a plurality of test cases against a software application, the test case result data describing a plurality of failed executions of a first test case of the plurality of test cases and a second plurality of failed executions of a second test case of the plurality of test cases;
accessing failed test case response data describing actions performed in response to at least a portion of the failed test case executions, the failed test case response data describing respective responses to the plurality of failed executions of the first test case and respective responses to the second plurality of failed executions of the second test case;
determining a first failure action metric value for the first test case based at least in part on a number of the respective responses to the plurality of failed executions of the first test case that included modifying the software application;
determining a second failure action metric value for the second test case based at least in part on a number of the respective responses to the second plurality of failed executions of the second test case that included modifying the software application;
selecting a subset of the plurality of test cases based at least in part on the first failure action metric value and the second failure action metric value, the subset of the plurality of test cases comprising the first test case and omitting the second test case; and
executing the subset of the plurality of test cases against the software application.
